(19) United States
(12) Patent Application Publication
(10) Pub. No.: US 2012/0021729 A1
(43) Pub. Date: Jan. 26, 2012

(54) Application Audio Announcements Using Wireless Protocols

(75) Inventors: Andreas TUERK, Woerthsee (DE); Bernd HOLZHEY, Neubiberg (DE); Markus MUEHLBAUER, Oberhaching (DE); Tobias HAAMEL, Munich (DE); Wieland HOLFELDER, Planegg (DE)

(73) Assignee: Google Inc., Mountain View, CA (US)

(21) Appl. No.: 13/249,998

(22) Filed: Sep. 30, 2011

Related U.S. Application Data
(63) Continuation of application No. 12/836,355, filed on Jul. 14, 2010.

(51) Int. Cl. H04W 4/00

(52) U.S. Cl. 455/414.1

(57) ABSTRACT

The present invention relates to methods and apparatus for using a wireless telephone communication protocol to make a non-telephonic audio announcement (NTAA). An apparatus to use a hands-free telephonic device to make a non-telephonic audio announcement (NTAA) includes an announcer module configured to receive the NTAA from an application. The announcer module is configured to send an outgoing call initiation command signal to the hands-free telephonic device using a hands-free communication protocol. After the call initiation command signal is sent, the announcer sends the NTAA to the hands free telephonic device using the hands-free communication protocol.

### CROSS REFERENCE TO RELATED APPLICATIONS

This patent application claims the benefit of U.S. patent application Ser. No. 12/836,335 filed on Jul. 14, 2010, entitled “Application Audio Announcements Using Wireless Protocols,” which is incorporated by reference herein in its entirety.

### FIELD

The present application generally relates to audio announcements made by mobile applications.

### BACKGROUND

Modern applications executed on cell phones and other contexts are increasingly interacting with users. Audio announcements made by an application are one form of interaction used in many different types of applications, e.g., navigation applications. In many circumstances, audio announcements made on the small speakers of a mobile device may be difficult to hear for a user, for example, when a mobile navigation application is announcing directions to a driver-user in an automobile. With mobile navigation applications, the need for precisely hearing audio announcements is increased by the complexity and importance of the announcements made.

Conventional approaches to connecting mobile devices to external input/output devices for the purposes of performing audio announcements and receiving audio commands do not provide a full featured user experience. Connecting a mobile device to a car stereo using a wired connection or an FM transmitter is one solution, but users increasingly enjoy a wireless connection between their mobile devices and telephonic input/output devices like phone headsets and hands-free mobile devices.

Wireless protocols do exist to connect the audio input and output of mobile devices to telephonic input/output devices, but these wireless protocols are traditionally used for the input and output of telephonic audio messages only, e.g., a mobile device wirelessly connecting to a headset or a “hands-free” speakerphone device for the purposes of making a phone call. An example wireless protocol that is used to make these wireless telephonic connections is the BLUETOOTH PROTOCOL (“Bluetooth”) by the Bluetooth Special Interest Group (SIG) of Kirkland, Wash. Protocols that are designed to facilitate telephonic connections are traditionally not used to input and output non-telephonic audio announcements, e.g., navigation directions from a mobile application.

Accordingly, what is needed are improved methods and apparatus for wirelessly providing non-telephonic audio announcements using a wireless protocol.

### BRIEF SUMMARY

Embodiments of the present invention relate to methods and apparatus for using a wireless telephone communication protocol to make a non-telephonic audio announcement (NTAA). According to an embodiment, an apparatus to use a hands-free telephonic device to make a non-telephonic audio announcement (NTAA) includes an announcer module configured to receive the NTAA from an application. Upon the receipt of the NTAA, the announcer module is configured to send, via a wireless protocol audio gateway, an outgoing call initiation command signal to the hands-free telephonic device using a hands-free communication protocol, the outgoing call initiation command signal not being associated with an outgoing call. After the call initiation command signal is sent, the announcer sends, via the wireless protocol audio gateway, the NTAA to the hands free telephonic device using the hands-free communication protocol.

According to another embodiment, a method of using a wireless telephone communication protocol to make a non-telephonic audio announcement (NTAA) is provided. The method includes receiving, at an announcer module operating on a first device, the NTAA from an application operated on a first device. The method further includes commanding, using a wireless protocol module also operating on the first device, a second device to initiate a telephone call using a first command signal, wherein the first command signal is not associated with an outgoing call. Finally the announcer module plays the NTAA on the second device using the wireless protocol module.

Further features and advantages, as well as the structure and operation of various embodiments are described in detail below with reference to the accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a system according to an embodiment of the present invention.

FIG. 2A is a diagram showing mobile devices according to an embodiment of the present invention.

FIG. 2B is a diagram showing I/O devices according to an embodiment of the present invention.

FIG. 3 is a more detailed diagram of a mobile device according to an embodiment of the present invention.

FIG. 4A is a signaling diagram of aspects of a wireless communication protocol according to an embodiment of the present invention.

FIG. 4B is another signaling diagram of aspects of a wireless communication protocol according to an embodiment of the present invention.

FIG. 5 is a timeline comparing an embodiment with a conventional approach according to an embodiment of the present invention.

FIG. 6 is an additional diagram showing I/O devices according to an embodiment of the present invention.

FIG. 7A is another signaling diagram of aspects of a wireless communication protocol according to an embodiment of the present invention.

FIG. 7B is another signaling diagram of aspects of a wireless communication protocol according to an embodiment of the present invention.

FIG. 8 is a flowchart of a method of using a hands-free phone communication protocol to make a non-telephonic audio announcement (NTAA).

FIG. 9 is a flowchart of a method of using a hands-free phone communication protocol to receive a non-telephonic voice command (NTVC)

FIG. 10 depicts a sample computer system that can be used to implement an embodiment.

### DETAILED DESCRIPTION OF EMBODIMENTS

Embodiments described herein relate to providing systems and methods for providing non-telephonic audio announcements using a wireless communication protocol. Other embodiments described herein relate to providing methods and apparatus for receiving voice commands using a wireless protocol. One approach is described that allows embodiments, in a non-limiting example, to provide an audio announcement using a hands-free wireless protocol, e.g., the Bluetooth Hands-Free Protocol (HFP). Another approach is described that allow embodiments, in a non-limiting example, to provide an audio announcement using a headset wireless protocol, e.g., the Bluetooth Headset Protocol (HSP).

While specific configurations, arrangements, and steps are discussed, it should be understood that this is done for illustrative purposes only. As would be apparent to a person skilled in the art given this description, other configurations, arrangements, and steps may be used without departing from the spirit and scope of the present invention. It would be apparent to a person skilled in the art given this description, that these embodiments may also be employed in a variety of other applications.

It should be noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art given this description to incorporate such, a feature, structure, or characteristic in connection with other embodiments whether or not explicitly described.

### System

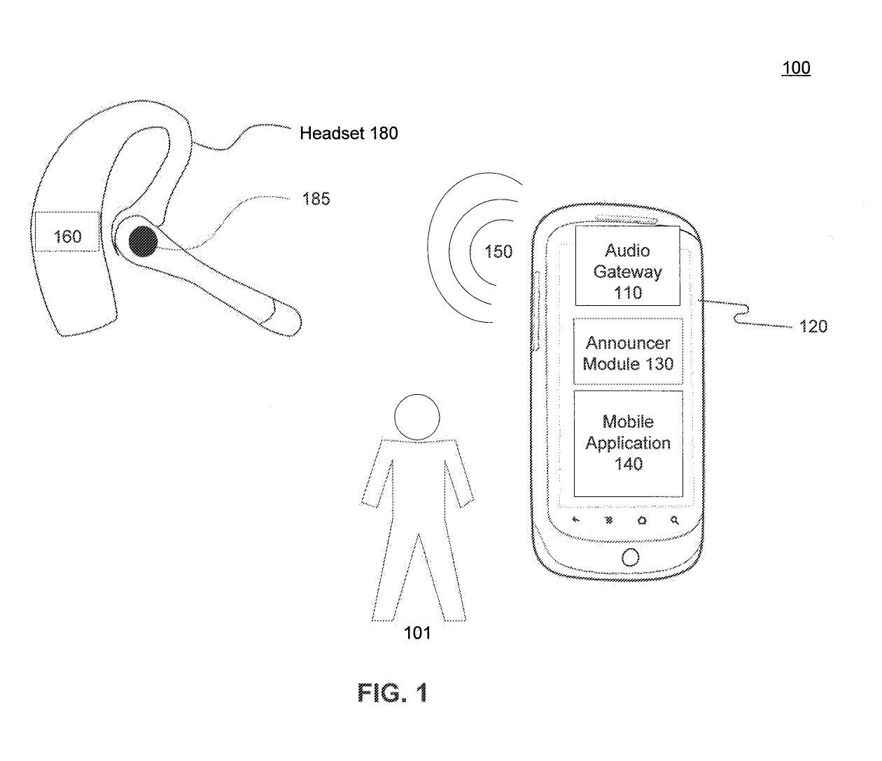

FIG. 1 shows a diagram illustrating system 100 for providing non-telephonic audio announcements (NTAA) using a wireless communication protocol. In an embodiment, system 100 includes headset device 180 and mobile device 120. Headset device 180 includes antenna 160 and speaker 185, and mobile device 120 includes audio gateway 110, announcer module 130 and mobile application 140.

As used herein, the term “wireless connection protocol” refers to a standard for exchanging data wirelessly. As would be appreciated by one having skill in the relevant arts, a component that is configured to generate signals according to a wireless connection protocol can be termed a “wireless protocol module.” Aspects of a wireless protocol module can be implemented, in embodiments, in hardware or software. In an embodiment, wireless data exchange can occur over short distances between fixed and mobile devices.

An example of a wireless connection protocol used by some embodiments is the Bluetooth profile. Several examples used herein will illustrate different embodiments by describing specific Bluetooth connection and communication aspects. In should be understood that these examples may only illustrate certain relevant portions of embodiments and the Bluetooth protocol and may not detail all aspects. An example wireless protocol module can be a Bluetooth protocol specific wireless protocol module, e.g., a module that is configured to generate signals according to the Bluetooth protocol. Those having skill in the relevant art, with access to the teachings herein, would appreciate how to implement the Bluetooth protocol, as well as other wireless protocols, to create embodiments and variations thereof described herein.

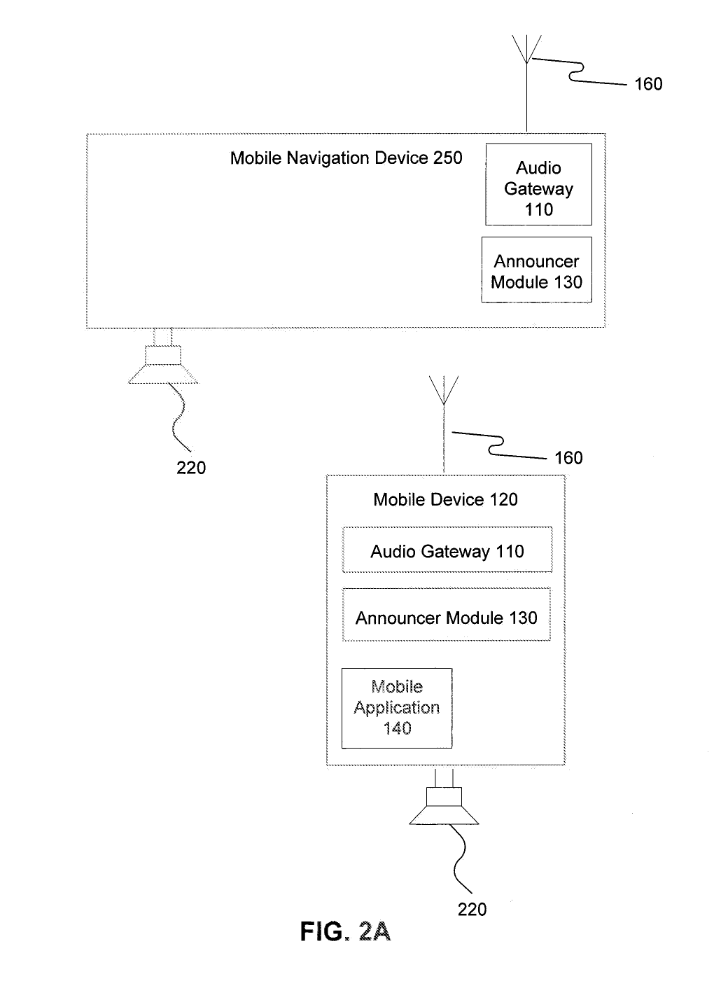

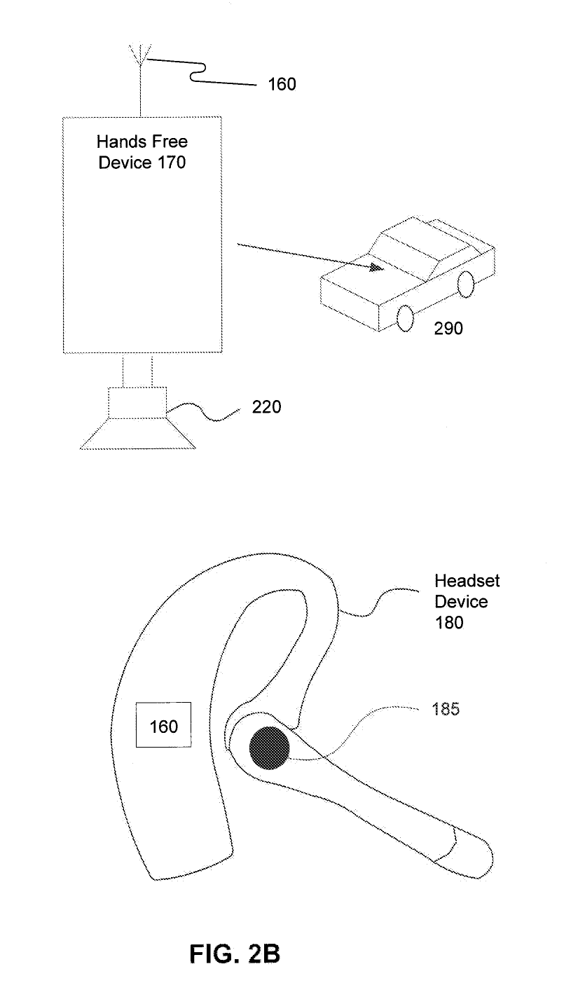

Different wireless communication protocols have different capabilities and methods of connecting to various devices, and these methods are often termed “profiles.” One type of profile or method used to connect a wireless peripheral to a device is a profile that is used to connect wireless headset device 180 to a device, e.g. mobile device 120. One example of a profile used to connect to headset device 180 is the Bluetooth Headset Profile (HSP). Another example of a profile that can be used to connect to mobile device 120 is the Bluetooth Hands-Free Profile (HFP), such profile being used to connect to a hands-free device, e.g., a hands-free speaker-phone device, as noted below with the discussion of FIG. 2B.

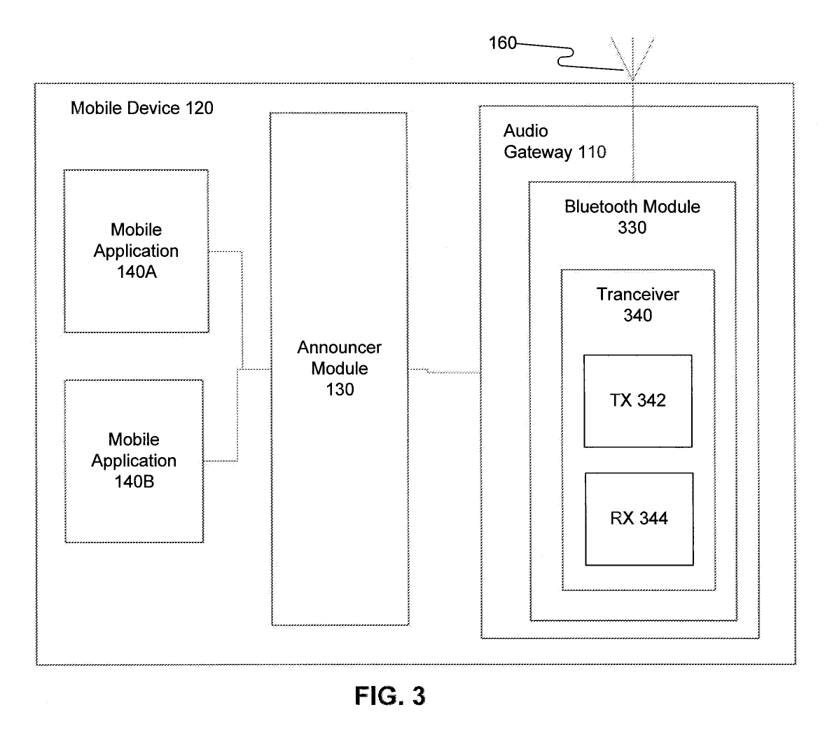

In general, system 100 operates as follows. In an embodiment, mobile application 140 prepares an NTAA to deliver to user 101. This NTAA is delivered to audio gateway 110, and audio gateway 110 establishes a wireless connection to headset device 180. Further detail concerning the mechanics of embodiments of this connection are noted with the discussion of FIG. 3.

In embodiments, mobile device 120, the device from which the audio announcements originate, can be a variety of different types of devices, e.g., a mobile phone, a mobile navigation device using GPS, and a vehicle computer system. Motile device 120, in an embodiment described herein, includes a capability of communicating by wireless communication with a speaker/microphone peripheral, e.g., a headset or external speaker.

FIG. 2A depicts mobile device 120 in additional detail, and introduces mobile navigation device 250. In the embodiment shown, both mobile device 120 and mobile navigation device 250 include audio gateway 110, announcer module 130, speaker 220 and antenna 160. Mobile device 120 further includes mobile application 140. Mobile navigation device 250 may not have separately installable mobile applications 140, so as described herein, their internal navigation logic (not shown) functions as the equivalent of mobile application 140.

Mobile application 140 enables mobile device 120 to perform different functions, many of which utilize NTAA to communicate with user 101. In conventional usage, mobile device 120 uses speaker 220 to play these NTAA for user 101. As noted in the Background above however, speaker 220 has limitations in certain situations, e.g., playing audible directions from a navigation application in a moving car.

The following list of mobile application 140 examples is non-limiting, and meant to describe different types of applications and associated NTAA:

App1: A navigation application, e.g., GOOGLE MAPS from Google Inc. of Mountain View, Calif., that audibly gives turn-by-turn directions to user 101.

App2: An audio book application that turns text of a book into spoken words for user 101.

App3: An email application, e.g., GMAIL from Google Inc., that gives audible notification that an email has arrived for the user. In different embodiment, this audible notification may be different for different circumstances.

The above examples App1-App3 are meant to be illustrative and not intended to limit the embodiments described herein. As would be apparent to a person skilled in the art given this description, other types of applications and NTAA could be used by embodiments. In further examples, mobile device 120 may enable a user to download and install further applications 140 that add additional functionality to mobile device 120. In another embodiment, mobile device 120 is running the ANDRIOD operating system, available from Google Inc.

FIG. 2B depicts two I/O devices usable by embodiments: hands free device 170, includes speaker 220 and antenna 160, and headset device 180 includes speaker 185 and antenna 160. Hands-free device 170 depicted as being installed in automobile 290.

Automobiles 290 can have hands-free devices 170 whereby a mobile phone connects via a wireless protocol, e.g. the Bluetooth Hands-Free profile, to make phone calls. Such calls are broadcast over the car speakers, and can, in an embodiment, interrupt audio playing on the car audio system, e.g., when connected mobile phone device 120 places/receives a call, the song playing on the car stereo will be muted or paused.

FIG. 3 depicts a more detailed view of mobile device 120. In an embodiment, mobile device 120 includes announcer module 130, mobile application 140A-B and audio gateway 110. Audio gateway 110 includes Bluetooth module 330. Bluetooth module 330 includes antenna 160 and transceiver 340, such transceiver including a transmitter (TX) 342 and a receiver (RX) 344.

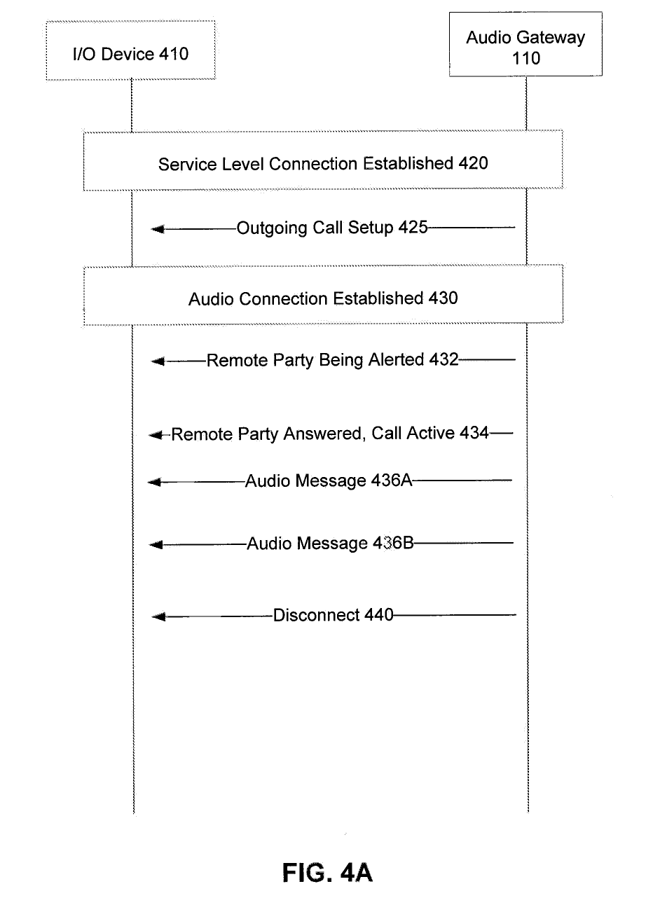

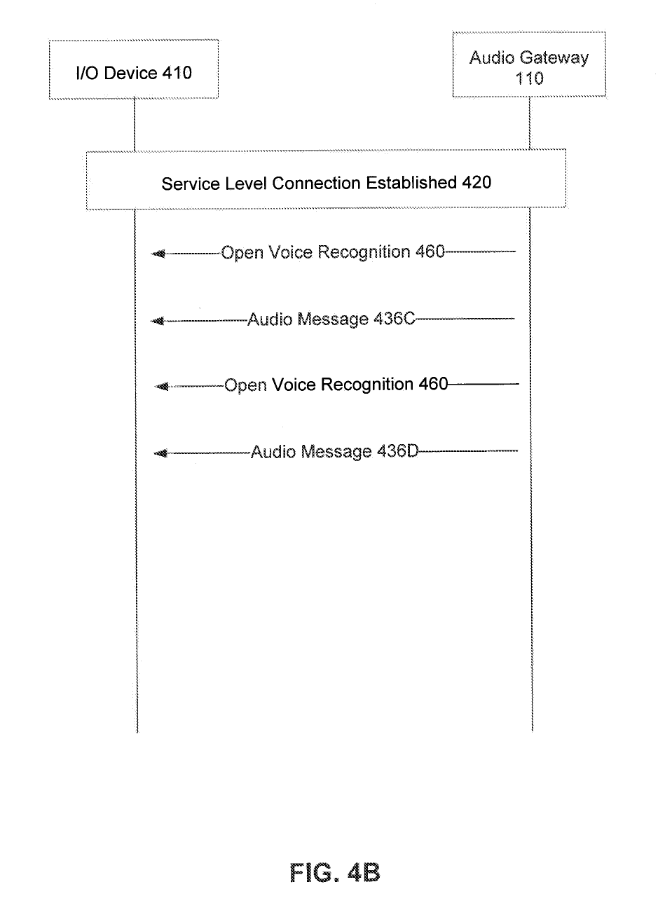

In an embodiment, Bluetooth module 330 receives and transmits a wireless signal utilizing the Bluetooth protocol. In an embodiment, as noted above, Bluetooth module 330 uses the Bluetooth Headset Profile (HSP) and in another embodiment Bluetooth module 330 uses the Bluetooth Hands-Free Profile (HFP). The wireless signal transmitted by transmitter 342 includes respective profile command messages used to send Bluetooth profile command signals, such command-use by embodiments being discussed further with the description of FIGS. 4A-B. Inbound data or audio is received by receiver 344, and relayed to announcer module 130 for relay to mobile application 140.

FIGS. 4A and 4B depict two different example approaches to wirelessly sending audio announcements, each used by an embodiment. The “signaling diagram” notation of diagram of FIGS. 4A-B and 7A-B would be known by one having skill in the art as describing command signals and events associated with the Bluetooth wireless communication protocol, but the items depicted thereon could apply to different embodiments using similar wireless protocols as well. The signals and events are shown over time on a vertical axis from top to bottom. In an embodiment, audio gateway 110 sends signals, some being Bluetooth Protocol as command messages, from right to left on FIG. 2A via transceiver 340.

In the first approach, detailed on FIG. 4A, audio gateway 110 uses a “call initiation” approach to establish an audio channel with I/O device 410. In an embodiment of this approach, audio gateway 110 is configured to, upon the request of announcer module 130, perform a sequence of steps that are the substantial equivalent of the initiation of a telephone call, with I/O device 410 as the input/output mechanism for the call. The sequence of steps detailed on FIG. 4A, and described below are intended to be a non-limiting embodiment performing these steps with a Bluetooth wireless connection, and using Bluetooth profiles.

In step 420, a “service level connection” is established between audio gateway 110 and I/O device 410. This service level connection is a pairing between respective Bluetooth devices, and the specifics of this step would be appreciated by one having skill in the relevant art. In a non-Bluetooth wireless embodiment, this connection could be any connection that facilitated the exchange of additional commands between devices. In an embodiment, once this service level connection has been established between I/O device 410 and audio gateway 110, it generally does not need to be reestablished unless it is terminated by distance, interference, etc. One having skill in the relevant art would appreciate the specifics of service level connections.

In step 425, audio gateway 110 sends a signal to I/O device 410 indicating a telephone call has been successfully initiated on the mobile device 120 connected to audio gateway 110. In one example of how this signal is conventionally used, this is the signal that is sent to the I/O device at the time the “send” button is pressed on mobile device 120. In an embodiment, no actual call initiation event is taking place.

In an embodiment that uses the Bluetooth protocol, with a hands-free device 180 as I/O device 410, audio gateway sends a “+CIEV” result code to hands-free device 180 (I/O device 410) with the value “callsetup=2” to notify hands-free device 180 that the call set-up has been successfully initiated. In the Bluetooth protocol embodiment, the successful completion of step 425, an audio connection established event 430 occurs.

In step 432, audio gateway 110 sends a signal to I/O device 410 indicating that a remote party is being alerted of the pending telephone call. In one example of how this signal is conventionally used, this is the signal that is sent to I/O device 410 at the time the telephone is “ringing,” e.g., mobile device 120 is audibly playing a ringing noise, and the receiving phone of the pending call is ringing as well. In an embodiment, no actual “ringing” event is taking place.

In an embodiment that uses the Bluetooth protocol, with a hands-free device 180 as I/O device 410, audio gateway sends a “+CIEV” result code to hands-free device 180 (I/O device 410) with the value “callsetup=3” to notify hands-free device 180 that the alerting of the remote party has been successfully initiated.

In step 434, audio gateway 110 sends a signal to I/O device 410 indicating that a telephone call has been successfully initiated. In one example of how this signal is conventionally used, this is the signal that is sent to I/O device 410 at the time that a telephone call is answered by a remote party. In an embodiment, no actual answering event is taking place, and no telephone call has been successfully initiated.

In an embodiment that uses the Bluetooth protocol, with a hands-free device 180 as I/O device 410, audio gateway sends a “+CIEV” result code to hands-free device 180 (I/O device 410) with the value “call=1” to notify hands-free device 180 that the alerting of the remote party has picked up the call, and that the call has been successfully initiated. One having skill in the relevant art will appreciate that, in an embodiment that uses a different wireless communication protocol, any sequence of connection steps and communication signals, that leads up to this “call initiated” event could be used.

At steps 436A-B, audio gateway 110 sends a signal to I/O device 410 that includes a non-telephonic audio announcement (NTAA) 436 from mobile application 140, where it is played through speakers (hands-free speaker 220 or headset speaker 185) for user 101. In one example of how this signal is conventionally used, this is the signal that is sent to I/O device 410 that includes the audio message of a telephone call. As used by an embodiment, this is a non-telephonic audio message, and could be any message, including ones from mobile application 140, as described above with FIG. 1, e.g., a navigation message from a navigation application. In an embodiment, though a message is sent from audio gateway 110 indicating that a call is in progress, no actual telephone call is taking place. In an embodiment, there is no limit to the number of NTAA 436 that can be sent by audio gateway 110.

In an embodiment, at step 440, when the current set of NTAA 436 is completed, audio gateway 110 sends a signal to I/O device 410 indicating that the “telephone call” on mobile device 120 has ended. In one example of how this signal is conventionally used, this is the signal that is sent to I/O device 410 at the time the user presses the “end” button on mobile device 120, ending a phone call. In an embodiment, no actual call has been ended.

In an embodiment that uses the Bluetooth protocol, with a hands-free device 180 as I/O device 410, at step 440, audio gateway sends a “+CIEV” result code to hands-free device 180 (I/O device 410) with the value “call=0” to notify hands-free device 180 that the “telephone call” has been successfully terminated.

In the above examples, the specifics of the Bluetooth Hands-Free Profile (HFP) are described. One with skill in the relevant art would realize that, in another embodiment, similar call initiation, announcement and termination steps can be utilized for other Bluetooth profiles, e.g., the Bluetooth Headset Profile (HSP).

In an additional function (not shown), if, in an example, user 101 was on an actual wireless telephone call using, for example, a Bluetooth Headset Profile (HSP) connection between mobile device 120 and headset device 180, user 101 could receive NTAA 436A during the call. In an embodiment, the Bluetooth Protocol includes a three-way calling feature, such feature allowing a third “party” to be included in the audio stream between audio gateway 110 and I/O device 410. An embodiment uses the Bluetooth command signals associated with this feature to include NTAA 436A in the conversation between user 101 and the other party to the call. One skilled in the art would recognize how to implement this approach in other wireless protocols that have a three-way calling feature.

In FIG. 4B, a second approach to wirelessly sending NTAA 436 to I/O device 410 is depicted. In this approach, audio gateway 110 uses an “initiate voice recognition” approach to establish an audio channel with I/O device 410. In an embodiment of this approach, audio gateway 110 is configured to, upon the request of a mobile device, perform a sequence of steps that are the substantial equivalent of an indication to I/O device 410 that a voice recognition command is requested, with I/O device 410 as the input/output mechanism for the command. The sequence of steps detailed on FIG. 4B, and described below are intended to be a non-limiting embodiment performing these steps with a Bluetooth wireless connection, and using Bluetooth profiles.

In an embodiment, as depicted on FIG. 4B and as detailed in the description of FIG. 4A, at step 420, a “service level connection” is established between audio gateway 110 and I/O device 410. In step 460, audio gateway 110 sends a signal to I/O device 410 indicating mobile device 120 is requesting a voice-dialing command. In one example of how this signal is conventionally used, this is the signal that is sent to I/O device 410 at the time that a user presses a “voice dialing” button on mobile device 120. In an embodiment, no voice dialing event is taking place. In some wireless communication protocols, e.g., Bluetooth, after this voice recognition signal is sent to I/O device 410, I/O device 410 prepares to receive and play using speakers 220, 185, an audible prompt from mobile device 120. In an example of the traditional usage, this audio prompt can be “please say a party to call” signifying a request for an associated telephone device to place a call to a contact.

In an embodiment that uses the Bluetooth protocol, with a headset device 180 as I/O device 410, audio gateway 110 sends a “+BVRA” result code to hands-free device 180 (I/O device 410) with the value “1” to notify hands-free device 180 that a voice recognition is being initiated. In the Bluetooth protocol embodiment, the successful completion of step 460, a NTAA 436C is sent from audio gateway 110 to I/O device. The voice recognition signal does not initiate a “call,” as in FIG. 4A, rather it opens the audio signal to output from audio gateway 110. In an embodiment, once the NTAA is sent to I/O device 410, a “+BVRA” result code is sent to I/O device 410 with the value “0” to notify that voice recognition has ended.

In an embodiment, after the successful completion of step 460, audio gateway 110 sends NTAA 436C to I/O device 410, where it is played through speaker 220 for user 101. If an additional non-telephonic audio message is required to be played, in embodiments audio gateway 110 must send another open voice recognition 460 signal to I/O device 410. Once this 460 signal has been sent, an additional NTAA 436D can be sent. As would be appreciated by one having skill in the art, this requirement is based on the requirements of the Bluetooth profile voice dialing command.

It should be noted that in some embodiments where audio gateway 110 is connecting to hands-free device 170, the “call initiation” approach detailed on FIG. 4A is the only approach that is used. In an embodiment, the “voice recognition” approach as detailed on FIG. 4B is not available for connections between audio gateway 110 and hands-free device 170 as I/O device 410. In many embodiments of hands-free device 170, this “voice recognition” approach is not supported by the hardware, and thus the “call initiation” approach detailed on FIG. 4A must be used.

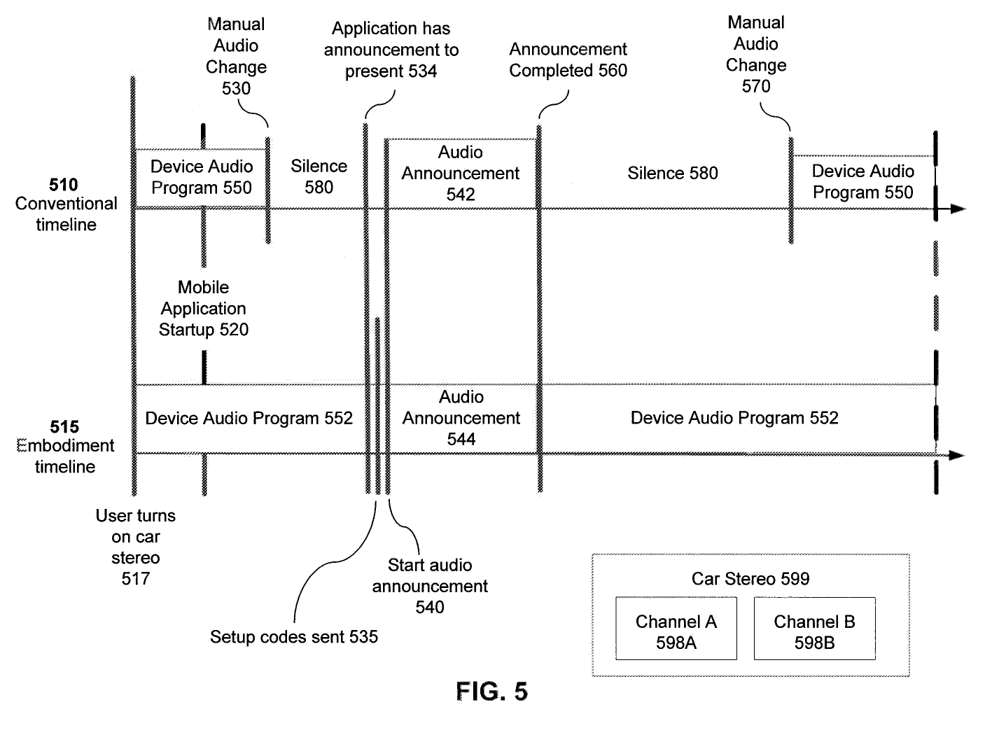

FIG. 5 depicts two parallel timelines that show a conventional timeline 310, and an embodiment timeline 315. Both timelines show audio played on a device set to receive audio signals from a wireless communication protocol, e.g., a hands free device 170 in an automobile 290.

As shown on FIG. 5, traditional approaches exist for wireless communication of audio announcements between a mobile device and receiver devices. One example of such a traditional approach involves a personal navigation device and a car stereo system. Automobile 290 stereo systems typically have a receiver for FM radio signals, and allow user 101 to tune the stereo receiver to receive different signals. Local FM transmitters broadcast a low-power FM signal and are coupled to different devices, e.g., MP3 players to allow the device audio to be directly played on the stereo without any wired connection. With respect to audio announcements by mobile navigation device 250, a traditional wireless connection involves a low-powered FM broadcast either by mobile navigation device 250 or by a device coupled to mobile navigation device 250. This traditional approach ostensibly allows the wireless broadcast of audio announcements from the mobile navigation device 250 to user 101 via the car stereo.

FIG. 5 depicts some aspects of this FM wireless approach as compared to some embodiments described herein. Both conventional timeline 510 and embodiment timeline 515 begin with user 101 turning on 517 car stereo 599 in automobile 290. In the example, the user on both timelines turns on device audio program 550, 552 to be played on their car stereo. In this example, both audio programs 550, 552 are a local FM radio station, the FM channel corresponding to channel A 598A.

Continuing this example, at point 520, on both timelines, user 101 starts a mobile application 520 on their mobile device 120, e.g., a navigation application. At this point 520, the device audio program 550, 552 from channel A 598A continues to play audio for the user. At point 530, because user 101 has decided to receive audio announcements from the traditional FM broadcast approach user 101 changes the tuned FM channel on car stereo 599 to channel B, 598B. Because mobile application 140 is not making an audio announcement, silence 580 results. In contrast to conventional 510, on embodiment timeline 515 as described below, no manual audio change 530 needs to be made.

At point 534 on both timelines, mobile application 140 has an audio announcement 542 to present. On conventional timeline 510, this audio announcement 542 is relayed to the above described FM transmitter on channel B 528B, and it is received by car stereo 599 and played for user 101 at point 534.

In contrast to conventional timeline 510, on embodiment timeline 515, as described above with FIGS. 2A-B, at point 534, announcer module 130 receives the audio announcement from mobile application 140 and sends setup codes 535 to establish the audio connection with a receiver device, e.g., a hands free device 170 installed in automobile 290. As would be known by one having skill in the art, embodiments of the example receiver device—the hands free device—have a function whereby when a call comes in, car stereo 599 audio program, e.g., channel A 598A described above, is interrupted, and hands free device 170 takes exclusive control of audio played in automobile 290. Accordingly, at step 540 on embodiment timeline 515, audio program 552 is interrupted automatically and audio announcement 544 is played for user 101.

At point 560 on both timelines, audio announcement 542, 544 completes. On conventional timeline 510, channel B 598B returns to silence 180, while on embodiment timeline 515, audio program 552, e.g., music, returns to exclusive playing on car stereo 599. If additional audio announcements are made, the cycle from embodiment timeline 515 repeats. At point 570 on conventional timeline, 510, user 101 decides to turn off audio announcement capability to return to device audio program 550 on channel A 598A.

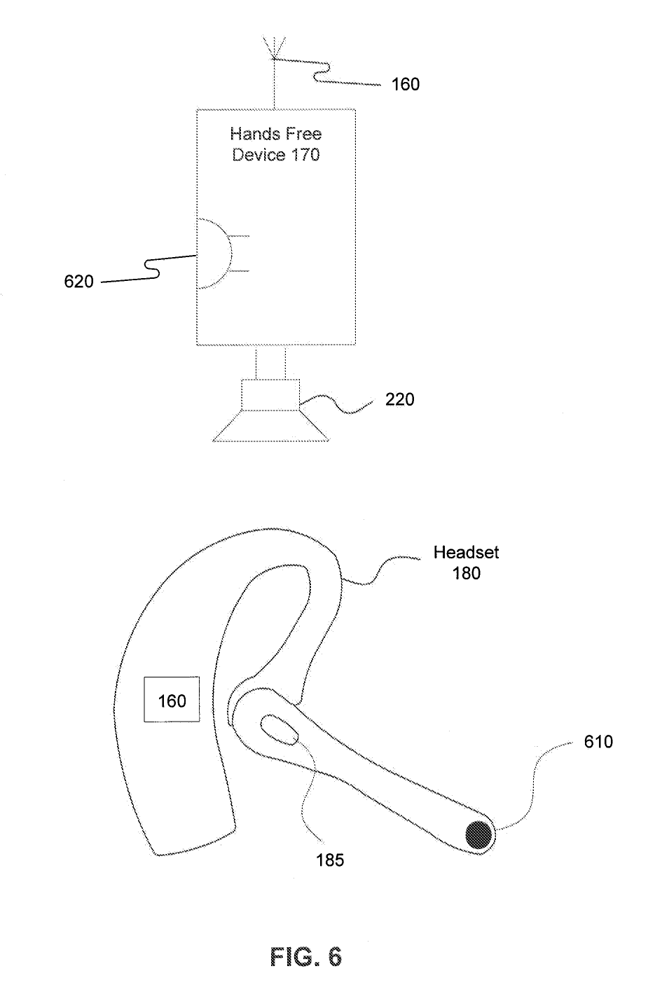

FIG. 6 depicts hands-free device 170 and headset device 180 as described in FIG. 1, each further comprising microphone (610, 620), and each, according to an embodiment, able to receive an audio stream from user 101. In an embodiment, this received audio stream can be relayed to mobile application 140 via audio gateway 110 and announcer module 130. As would be appreciated by one having skill in the relevant art, this audio stream can be used by mobile application 140 to perform a variety of functions, including specifying an address to which to navigate and performing an internet search based on search terms spoken.

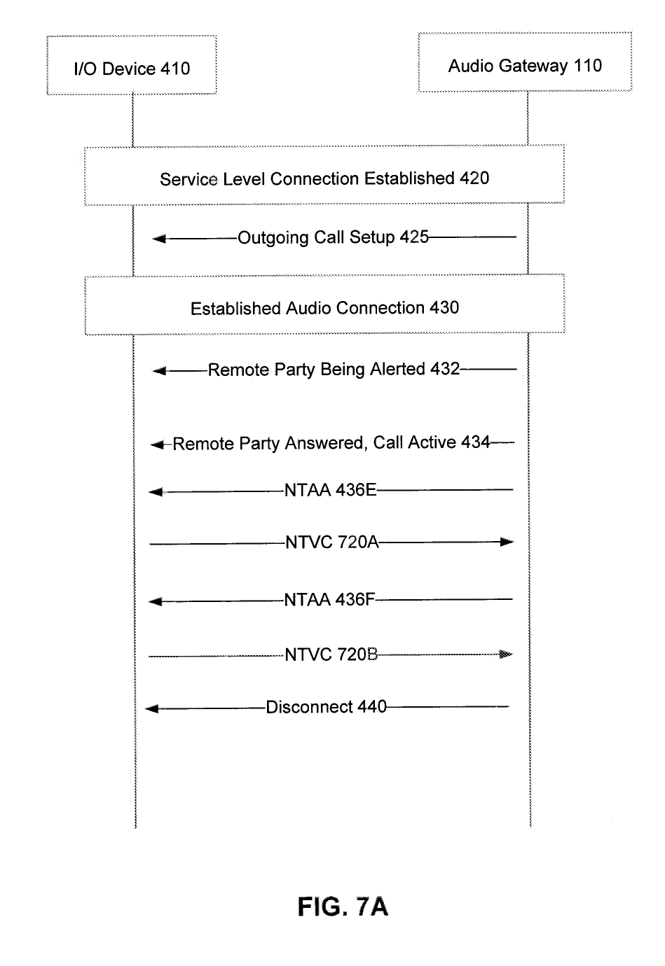

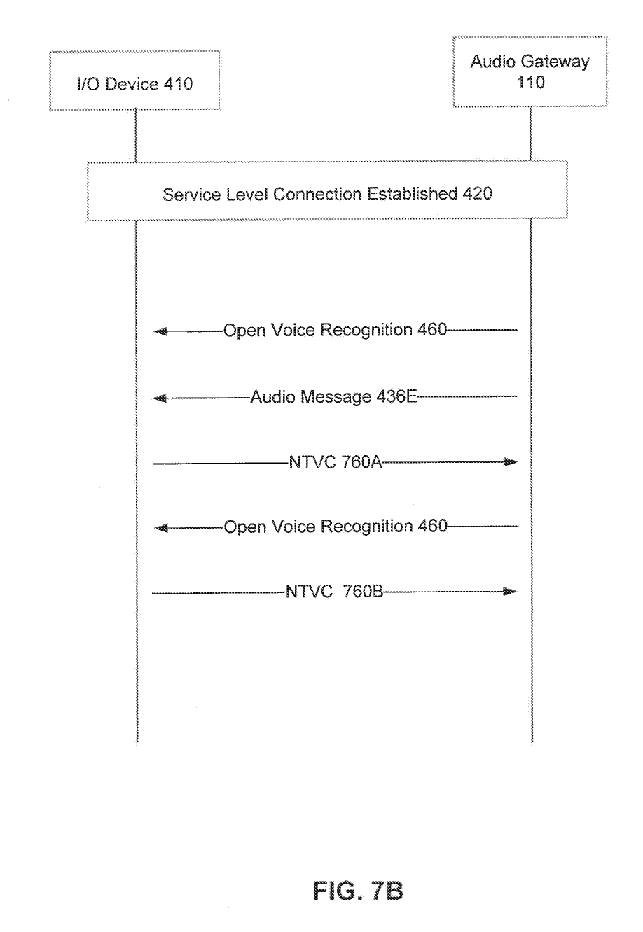

FIG. 7A depicts an embodiment implementing audio capture that is similar to the embodiment described in FIG. 4A, where audio gateway 110 uses a “call initiation” approach to establish an audio channel with I/O device 410. In an embodiment depicted in FIG. 7A, the steps described in FIG. 4A are followed but additionally, after NTAA 436A is sent by audio gateway 110, non-telephonic voice command (NTVC) 720A is captured by microphone (610, 620) and sent to audio gateway 110.

In an embodiment, after the “call active” step 434, as described with FIG. 4, a full-duplex audio-channel is open between I/O device 410 and audio gateway 110. In this embodiment, the open audio channel allows for exchange of NTAA 436 between I/O device 410 and audio gateway 110 until the disconnect step 440. Thus as depicted on FIG. 7A, in an embodiment, during the zone depicted, any combination of NTAAs (436E, 436F) and user NTVC (720A, 720B) can be exchanged respectively between I/O device 410 and audio gateway 110.

In an embodiment, this approach can be used with both hands-free device 170 and headset device 180, e.g., with the Bluetooth Headset Profile (HSP) and Hands-Free Profile (HFP) respectively.

FIG. 7B depicts an embodiment similar to the embodiment described in FIG. 4B, where audio gateway 110 uses an “initiate voice recognition” approach to establish an audio channel between audio gateway 110 and I/O device 410. In an embodiment depicted in FIG. 7B, the steps described in FIG. 4B are followed but additionally, after NTAA 436E is sent by audio gateway 110, non-telephonic voice command (NTVC) 760A is captured by microphone (610, 620) and sent to audio gateway 110. In an embodiment from audio gateway 110, NTVC 760A can be relayed to announcer module 130 then routed to the appropriate mobile application 140A, 140B. If an additional NTVC 760B is required, in an embodiment, another open voice recognition command signal 460 can, in an embodiment, need to be sent to reopen the audio channel between audio gateway 110 and I/O device 410.

In an embodiment of a mobile application 140, NTVC 760 could direct some function in, for example, the mobile navigation application noted above—e.g., “cancel trip.”

### Method

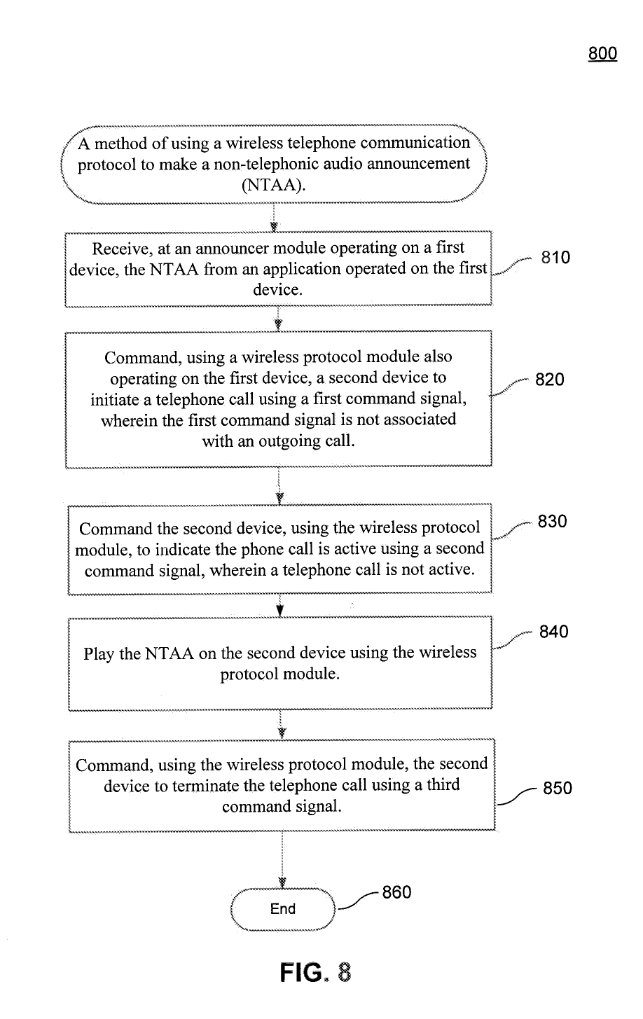

FIG. 8 illustrates a more detailed view of how embodiments described herein may interact with other aspects of embodiments. In this example, a method of using a wireless telephone communication protocol to make a non-telephonic audio announcement (NTAA) is shown. Initially, as shown in stage 810, an announcer module operating on a first device, receives the NTAA from an application operated on the first device. At stage 820, using a wireless protocol module also operating on the first device, a second device is commanded to initiate a telephone call using a first command signal, wherein the first command signal is not associated with an outgoing call. At stage 830, the second device is commanded, using the wireless protocol module, to indicate the phone call is active using a second command signal, wherein a telephone call is not active. At stage 840, the NTAA is played on the second device, using the wireless protocol module. At stage 850, the second device is commanded, using the wireless protocol module, to terminate the telephone call, using a third command signal. At stage 860, the method ends.

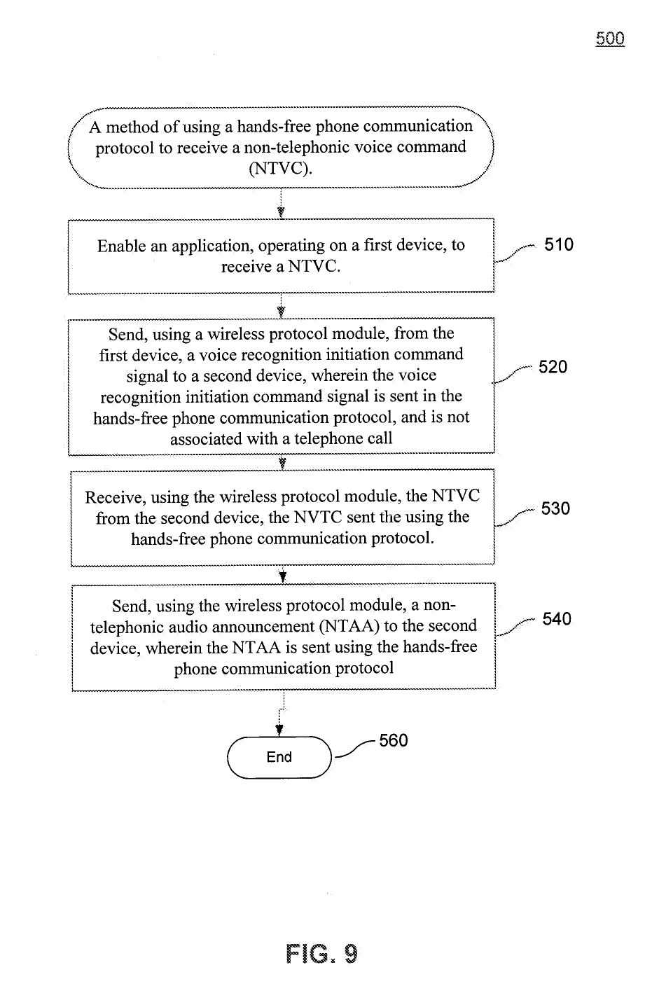

FIG. 9 illustrates a more detailed view of how embodiments described herein may interact with other aspects of embodiments. In this example, a method of using a hands-free phone communication protocol to receive a non-telephonic voice command (NTVC) is shown. Initially, as shown in stage 910, an application operating on a first device is enabled to receive the NTVC. At stage 920, a voice recognition initiation command signal is sent from the first device to a second device using a wireless protocol module, wherein the voice recognition initiation command signal is sent in the hands-free phone communication protocol, and is not associated with a telephone call. At stage 930, an NTVC is received from the second device using the wireless protocol module, wherein the NVTC is sent the using the hands-free phone communication protocol. At stage 940, a non-telephonic audio announcement (NTAA) is sent to the second device using the wireless protocol module, wherein the NTAA is sent using the hands-free phone communication protocol. At 960, the method ends.

### Example Computer System Implementation

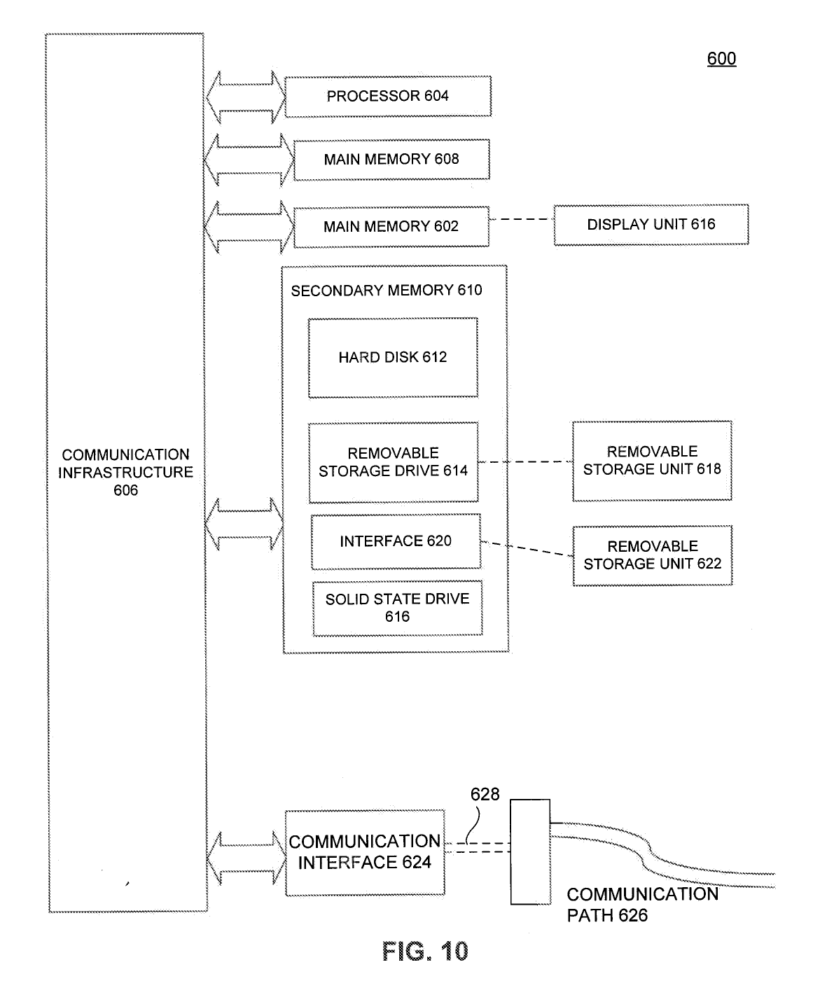

FIG. 10 illustrates an example computer system 1000 in which embodiments of the present invention, or portions thereof, may be implemented as computer-readable code. For example, system 100 and FIGS. 1-3, and 6, carrying out stages of method 800 of FIG. 8, and method 900 of FIG. 9, may be implemented on computer system 1000 using hardware, software, firmware, tangible computer readable media having instructions stored thereon, or a combination thereof and may be implemented in one or more computer systems or other processing systems. Hardware, software or any combination of such may embody any of the modules/components in FIGS. 1-3, 6 and any stage in FIGS. 8 and 9.

If programmable logic is used, such logic may execute on a commercially available processing platform or a special purpose device. One of ordinary skill in the art may appreciate that embodiments of the disclosed subject matter can be practiced with various computer system and computer-implemented device configurations, including smartphones, cell phones, mobile phones, GPS devices, personal/mobile navigation devices, slate PCs, “Pad” PCs, tablet PCs, multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 1000. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. As will be appreciated by persons skilled in the relevant art, processor device 1004 may also be a single processor in a multi-core/multiprocessor system, such system operating alone, or in a cluster of computing devices operating in a cluster or server farm. Processor device 1004 is connected to a communication infrastructure 1006, for example, a bus, message queue, network or multi-core message-passing scheme.

Computer system 1000 also includes a main memory 1008, for example, random access memory (RAM), and may also include a secondary memory 1010. Secondary memory 1010 may include, for example, a hard disk drive 1012, removable storage drive 1014 and solid state drive 1016. Removable storage drive 1014 may comprise a floppy disk drive, a magnetic tape drive, an optical disk drive, a flash memory, or the like. The removable storage drive 1014 reads from and/or writes to a removable storage unit 1018 in a well known manner. Removable storage unit 1018 may comprise a floppy disk, magnetic tape, optical disk, etc. which is read by and written to by removable storage drive 1014. As will be appreciated by persons skilled in the relevant art, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 may also include a communications interface 1024. Communications interface 1024 allows software and data to be transferred between computer system 1000 and external devices. Communications interface 1024 may include a modem, a network interface (such as an Ethernet card), a communications port, a PCMCIA slot and card, or the like. Software and data transferred via communications interface 1024 may be in the form of signals, which may be electronic, electromagnetic, optical, or other signals capable of being received by communications interface 1024. These signals may be provided to communications interface 1024 via a communications path 1026. Communications path 1026 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1018, removable storage unit 1022, and a hard disk installed in hard disk drive 1012. Computer program medium and computer usable medium may also refer to memories, such as main memory 1008 and secondary memory 1010, which may be memory semiconductors (e.g. DRAMs, etc.).

Computer programs (also called computer control logic) are stored in main memory 1008 and/or secondary memory 1010. Computer programs may also be received via communications interface 1024. Such computer programs, when executed, enable computer system 1000 to implement the present invention as discussed herein. In particular, the computer programs, when executed, enable processor device 1004 to implement the processes of the present invention, such as the stages in the method illustrated by flowchart 600 of FIG. 6 discussed above. Accordingly, such computer programs represent controllers of the computer system 1000. Where the invention is implemented using software, the software may be stored in a computer program product and loaded into computer system 1000 using removable storage drive 1014, interface 1020, hard disk drive 1012 or communications interface 1024.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### Conclusion

Embodiments described herein methods and apparatus for providing audio announcements using a wireless protocol. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A method of using a wireless telephone communication protocol to make a non-telephonic audio announcement (NTAA) comprising:
receiving, at an announcer module operating on a first device, the NTAA from an application operated on the first device;
commanding, using a wireless protocol module also operating on the first device, a second device to initiate a telephone call using a first command signal, wherein the first command signal is not associated with an outgoing call; and
playing the NTAA on the second device using the wireless protocol module.

2. The method of claim 1 wherein after the commanding of the second device to initiate the telephone call, the method further comprises commanding the second device, using the wireless protocol module, to indicate the phone call is active using a second command signal, wherein a telephone call is not active.

3. The method of claim 1 wherein after the playing of the NTAA, the method further comprises commanding, using the wireless protocol module, the second device to terminate the telephone call using a third command signal.

4. The method of claim 1, wherein the wireless protocol module uses a Bluetooth Hands-Free Profile (HFP) and first command signal is a Bluetooth HFP profile call initiation command signal.

5. The method of claim 2, wherein the wireless protocol module uses a Bluetooth Hands-Free Profile (HFP) and the second command signal is a Bluetooth (HFP) profile call active signal.

6. The method of claim 3, wherein the hands-free communication profile is Bluetooth Hands-Free Profile (HFP) and the hangup signal is a Bluetooth (HFP) hangup signal.

7. The method of claim 1, wherein the first device is a mobile device and the second device is a hands-free telephonic device.

8. The method of claim 7, wherein the hands-free telephonic device is located in a motor vehicle.

9. The method of claim 1, wherein the application is a mobile navigation application.

10. An apparatus to use a hands-free telephonic device to make a non-telephonic audio announcement (NTAA) comprising:
an announcer module configured to receive the NTAA from an application, wherein upon the receipt of the NTAA, the announcer module is configured to:
send, via a wireless protocol audio gateway, an outgoing call initiation command signal to the hands-free telephonic device using a hands-free communication protocol, wherein the outgoing call initiation command signal is not associated with an outgoing call; and
send, via the wireless protocol audio gateway, the NTAA to the hands free telephonic device using the hands-free communication protocol.

11. The apparatus of claim 10 wherein after the send the outgoing call initiation command signal stage, the announcer module is further configured to send a phone call active command signal to the hands free telephonic device using the hands-free communication protocol, wherein a phone call is not active.

12. The apparatus of claim 10 wherein after the send the NTAA stage, the announcer module is further configured to send a call hangup command signal to the hands-free telephonic device using the hands-free communication protocol.

13. The apparatus of claim 10, wherein the hands-free communication protocol is Bluetooth Hands-Free Profile (HFP) and the outgoing call initiation signal is a Bluetooth HFP call setup signal.

14. The apparatus of claim 11, wherein the hands-free communication protocol is Bluetooth Hands-Free Profile (HFP) and the signal indicating that a phone call is active is a Bluetooth (HFP) call active signal.

15. The apparatus of claim 10, wherein the announcer module is on a mobile device.

16. The apparatus of claim 10, wherein the hands-free telephonic device is installed in a motor vehicle.

17. The apparatus of claim 10, wherein the application is a mobile navigation application.

18. A method of using a hands-free phone communication protocol to receive a non-telephonic voice command (NTVC) comprising:
enabling an application, operating on a first device, to receive the NTVC;
sending, using a wireless protocol module, from the first device, a voice recognition initiation command signal to a second device, wherein the voice recognition initiation command signal is sent in the hands-free phone communication protocol, and is not associated with a telephone call; and
receiving, using the wireless protocol module, the NTVC from the second device, the NVTC sent the using the hands-free phone communication protocol.

19. The method of claim 18 wherein either immediately before or after the receiving of an NTVC, sending, using the wireless protocol module, a non-telephonic audio announcement (NTAA) to the second device, wherein the NTAA is sent using the hands-free phone communication protocol.

20. The method of claim 18, wherein the hands-free communication profile is Bluetooth Hands-Free Profile (HFP) and the voice recognition initiation command signal is a Bluetooth HFP voice recognition initiation command signal.

21. The method of claim 18, wherein the first device is a mobile device, the second device is a hands-free telephonic device, both devices enabled to use a Bluetooth Hands-Free Profile (HFP).

22. The method of claim 21, wherein the hands-free telephonic device is installed in a motor vehicle.

23. The method of claim 18, wherein the application is a mobile navigation application.

24. A method for selectively providing from a hands-free telephonic device either an audio program or a non-telephonic audio announcement (NTAA) from a mobile application:
playing an audio program on a speaker system attached to the hands-free telephonic device, wherein the speaker system is configured to output either the audio program or output from the hands-free telephonic device;
receiving, at an announcer module operating on a mobile device, the NTAA from the mobile application operated on the mobile device;
commanding, using a wireless protocol module also operating on the first device, the hands-free telephonic device to initiate a telephone call, using an outgoing call initiation command signal, wherein the outgoing call initiation command signal is not associated with an outgoing call; and
playing, using the wireless protocol module, the NTAA from the announcer module on the hands-free telephonic device, wherein the NTAA is played on the speaker system, and upon completion of the NTAA, the audio program resumes playing.

25. The method of claim 24, wherein the hands-free telephonic device is installed in a motor vehicle, and the mobile application is a mobile navigation application.
